(19) United States
(12) Patent Application Publication
(10) Pub. No.: US 2009/0240896 A1
(43) Pub. Date: Sep. 24, 2009

(54) MICROPROCESSOR COUPLED TO MULTI-PORT MEMORY

(75) Inventor: Se-Jin Kang, Seoul (JP)

Correspondence Address: BIRCH STEWART KOLASCH & BIRCH, PO BOX 747, FALLS CHURCH, VA, 22040-0747, US

(73) Assignee: MTEKVISION CO.,LTD., Seoul (KR)

(21) Appl. No.: 12/160,755

(22) PCT Filed: Nov. 27, 2006
(86) PCT No.: PCT/KR2006/005024

§ 371 Date: Dec. 15, 2008

(30) Foreign Application Priority Data
Jan. 12, 2006 (KR) 10-2006-0003665

(51) Int. Cl. G06F 12/00; G06F 13/00

(52) U.S. Cl. 711/149; 710/110; 711/E12.001

(57) ABSTRACT

A microprocessor being coupled to a dual-port memory is disclosed. The microprocessor has two or more external memory controllers, being coupled to a system bus. Each of the external memory controllers can be individually coupled to an external memory through its respective port. With the present invention, a plurality of elements (e.g. process module) can access the external memory at the same time, enabling a quick process of data.

### CROSS-REFERENCE TO RELATED APPLICATIONS

This application claims foreign priority benefits under 35 U.S.C. .sctn. 119(a)-(d) to PCT/KR2006/005024, filed Nov. 27, 2006, which is hereby incorporated by reference in its entirety.

### BACKGROUND

1. Technical Field

The present invention relates to a microprocessor, more specifically to a microprocessor coupled to a multi-port memory.

2. Description of the Related Art

A baseband processor of a mobile communication terminal not only handles the function of communication but also controls the operation of application processors for performing specific functions (e.g. multimedia file playback function, camera function, etc.). The baseband processor can also control the operation of devices (e.g. a display, external storage, etc.) disposed in the mobile communication terminal.

In general, a main backbone system and bus are determined in accordance with the processor used in its system in a microprocessor having a baseband processor. That is, each processor communicates data with a variety of peripheral devices, such as a memory and PCI controller, through a system bus, based on a local bus as its system backbone bus.

The system based on an ARM processor, which is commonly used recently, also uses an advanced high-performance bus (AHB) called AMBA (Advanced Microcontroller Bus Architecture) as its system bus, through which a variety of peripheral devices in the system and the processor are communicated.

The conventional ARM processor, however, was coupled to an external memory through one bus, and it was not possible for a plurality of elements to access an external memory at the same time. This was because an element could access the external memory only after another element, which was accessed to the external memory first, finished its operation, causing a bottleneck problem while processing data.

### SUMMARY

In order to solve the problems described above, the present invention provides a microprocessor coupled to a dual-port memory that can process data quickly by coupling a baseband processor to an external memory through a plurality of buses to allow a plurality of elements (e.g. a process module) to access an external memory simultaneously.

The present invention also provides a microprocessor coupled to a dual-port memory that can minimize a bottleneck problem when each processor in the baseband processor processes data by accessing the external memory.

Other objects of the present invention will become apparent through the preferred embodiments described below.

To solve the above problems, an aspect of the present invention features a microprocessor being coupled to an external memory through two or more buses.

The microprocessor in accordance with an embodiment of the present invention has two or more external memory controllers coupled to a system bus. Each of the external memory controllers is individually coupled to an external memory through its respective port.

The microprocessor can also have n (a natural number) processors coupled to the system bus and a master/slave, which is coupled to the system bus and has a plurality of modules accessing the external memory through the external memory controller by a control of a processor or a predetermined processor.

The microprocessor is an AMBA-based platform, and the system bus is an AHB bus.

The external memory, which is coupled to the microprocessor, can have two or more ports.

The microprocessor can be a baseband processor.

The microprocessor in accordance with another embodiment of the present invention has a processor, which is coupled to a system bus, an external memory controller, which is coupled to the system bus and processes data communication with an external memory, and a master/slave, which is coupled to the system bus and has a plurality of modules accessing the external memory through the external memory controller by a control of the processor. The external memory has two or more ports and is individually coupled to the external memory through each port.

The microprocessor can be an AMBA-based platform, and the system bus can be an AHB bus.

The external memory, which is coupled to the microprocessor, can have two or more ports.

The microprocessor can be a baseband processor.

### BRIEF DESCRIPTION OF THE DRAWINGS

FIG. 1 shows a block diagram of a typical structure of a conventional AMBA;

FIG. 2 shows a block diagram of an improved structure of a conventional AMBA;

FIG. 3 shows an AMBA structure in accordance with an embodiment of the present invention; and

FIG. 4 shows how a microprocessor and an external memory are coupled in accordance with an embodiment of the present invention.

### DETAILED DESCRIPTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

Moreover, when describing the present invention, in which a microprocessor and a memory having two or more ports are coupled through each of the ports, it will be assumed that the memory is a dual-port memory, for the convenience of description and understanding.

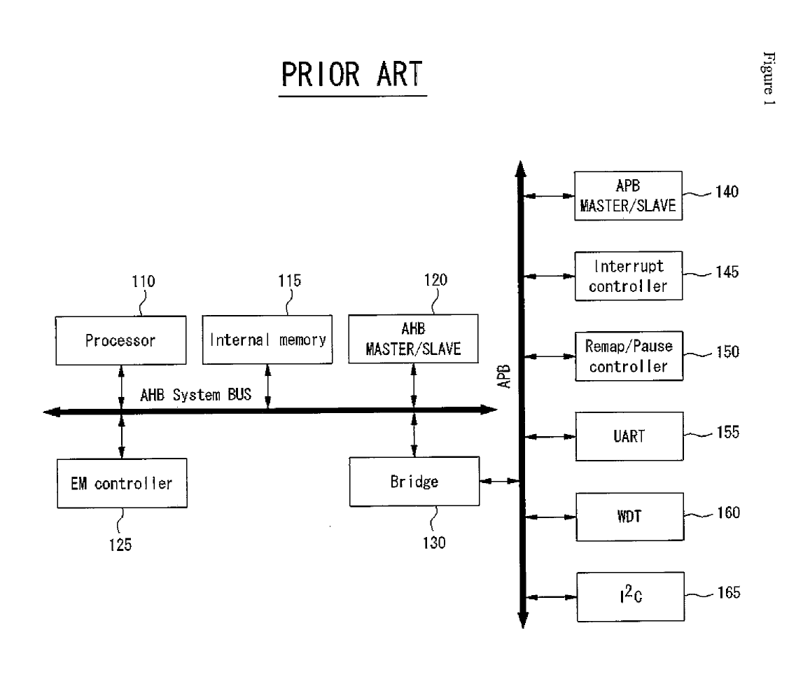

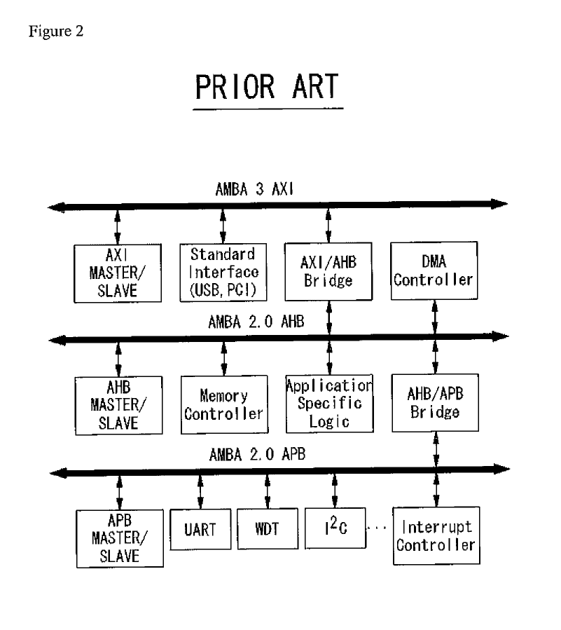

FIG. 1 is a typical structure of a conventional AMBA, and FIG. 2 is an improved structure of a conventional AMBA. In other words, FIGS. 1 and 2 outline how a wireless multimedia platform based on a conventional ARM/AHB is structured.

The AMBA (Advanced Microcontroller Bus Architecture) is generally accepted as the standard for one-chip communication for designing an embedded microprocessor.

Referring to the conventional ARM/AHB-based platform shown in FIG. 1, the AMBA-based microprocessor uses an AHB (advanced high-performance bus) as its backbone bus. An advanced peripheral bus (APB) can be used for peripheral macrocell communication. The APB is considered a local bus of the AHB, and is connected to the AHB by a bridge 130.

Connected to the AHB system bus are a processor 110, an internal memory 115, an AHB master/slave 120, an EM (external memory) controller 125, and a bridge 130.

In the internal memory 115, program codes and data are stored, and data of an external memory can be stored by the control of the EM controller 125, which controls input and output of data to and from an external memory.

The AHB master/slave 120 can include a plurality AHB masters, a plurality of AHB slaves, an AHB arbiter, and an AHB decoder.

The AHB master allows data to be read and/or written, by outputting an address or control signals. However, it is limited that one AHB master may use the AHB system bus at a time.

The AHB slave reads and writes data in a given address-space. The AHB slave reports to the AHB master the process status, such as failure, waiting, or success, occurred while reading and/or writing data.

The AHB arbiter allows one AHB master to be selected at a time. The AHB arbiter performs arbitration by use of a predetermined algorithm.

The AHB decoder selects an appropriate slave, with an upper level bit of an address outputted from the AHB master. The AHB also has one decoder.

Once the processor 110 requests the AHB master to have data read or written, the AHB master instructs the AHB slave to execute the corresponding operation. Since there are multiple AHB masters in the AHB master/slave 120, the AHB arbiter arbitrates in such a way that one AHB master is selected and that only the selected AHB master may use the AHB system bus. If the selected AHB master requests to read data for an address, the AHB decoder determines which AHB slave the address corresponds.

As such, the AHB masters and AHB slaves can write or read data in or from an external memory through the EM controller 125 having one port and I/O pins.

The conventional AMBA was structured to allow each module (i.e. the selected AHB master and/or selected AHB slave) to access an external memory by the control of one EM controller. Therefore, if one module accessed the external memory, other modules had to stand by until the external memory became available for access. This was a problem lowering the process efficiency of a microprocessor such as the baseband processor.

An APB bus, for accessing low-speed peripheral devices, is coupled to the AHB system bus via the bridge 130, and connected to the APB are an APB master/slave 140, a timer, an interrupt controller 145 for controlling an external interrupt, and a remap/pause controller 150 for enabling a remap/pause mode. A UART 155, a WDT 160, and an I2C 165 can be further connected.

The AMBA structure shown in FIG. 2 is based on AMBA 3.0, and is what the AMBA structure shown in FIG. 1 is improved.

AMBA 3.0 has an AXI (Advanced eXtensible Interface) bus in addition to an AHB bus for accessing high-speed peripheral devices or the processor and an APB bus for accessing low-speed peripheral devices. The functions and structure of the AXI bus are well-known to those of ordinary skill in the art and hence will not be described here.

In the improved AMBA structure shown in FIG. 2 also, each module can access an external memory through one EM controller, failing to resolve the problem described above.

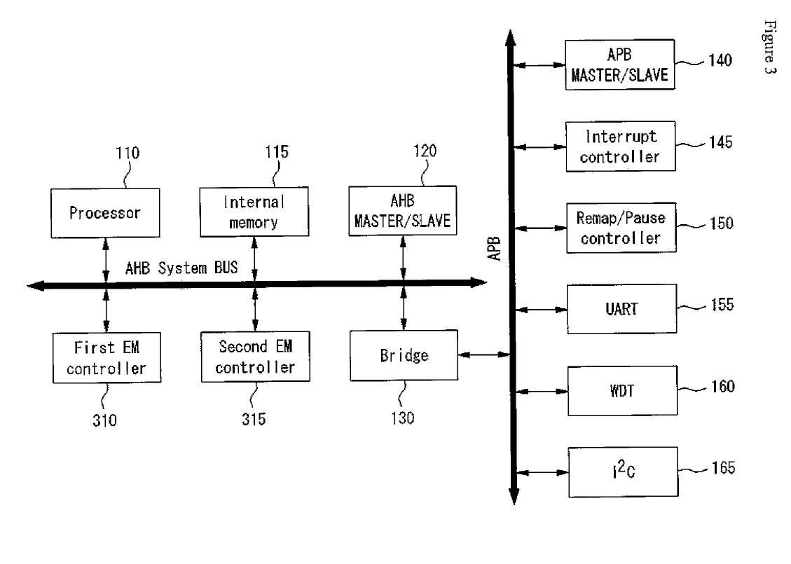

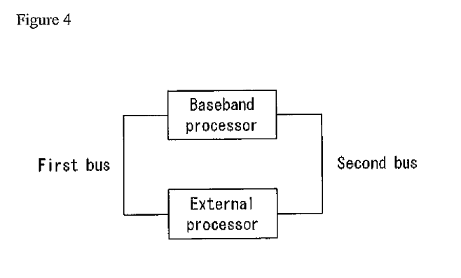

FIG. 3 shows an AMBA structure in accordance with an embodiment of the present invention, and FIG. 4 shows how a microprocessor and an external memory are coupled in accordance with an embodiment of the present invention.

The AMBA structure shown in FIG. 3 in accordance with an embodiment of the present invention is similar to the conventional AMBA structure described earlier with reference to FIG. 1, and hence only the differences will be described here.

The AHB system bus of a microprocessor (e.g. a baseband processor) in accordance with the present invention is connected to 2 EM controllers 310 and 315 for accessing an external memory. Each of the EM controllers 310 and 315 has one port and is coupled to the external memory (e.g. a dual-port memory) having two or more ports (refer to FIG. 4).

According to the present invention, therefore, the number of modules (e.g. the AHB master and AHB slave) that can be simultaneously coupled to the external memory can be increased to two or more. By this, a plurality of modules can simultaneously access the external memory to execute an operation, quickly processing data.

However, it would be necessary that the AHB arbiter and the AHB decoder can use the AHB system bus successively or that 2 AHB masters can use the AHB system bus simultaneously, and the corresponding AHB slaves should be able to operate. For this, the AHB system bus may have a parallel structure.

Which module should access the external memory through which EM controller can be controlled by one of the processor 110, the AHB master, and the AHB arbiter. For example, when the processor 110 instructs an operation to the AHB master, the EM controller to be used can be designated. Or, the EM controller to be used when the AHB master instructs an operation to the AHB slave or when the AHB arbiter arbitrates can be designated. Here, there can be n (a natural number) processors 110, and the EM controller, for example, can be designated by any processor or a predetermined processor.

Moreover, each EM controller can divide and manage a storage area of the external memory, controlling a module to be accessible to a particular storage area, in order to prevent a plurality of modules from accessing a same address of the external memory and writing data in the same address.

So far, the microprocessor structure, which allows 2 or more modules to access the external memory at the same time to execute an operation by having 2 or more EM controllers in the AHB system bus, has been described.

In the microprocessor structure in accordance with another embodiment of the present invention, the AHB system bus has one EM controller only, but the EM controller has 2 ports, each of which is coupled to each of 2 ports of the external memory, respectively.

Although this is done by one EM controller in this case, it is identical in that each of the plurality of modules is simultaneously accessible to the external memory through a different port. Here, which module should access the external memory through which port can be controlled by one of the processor 110, the AHB master, the AHB arbiter, and the EM controller.

Notwithstanding that no description is provided for this, anyone skilled in the art to which the invention pertains shall understand this through what has been described above.

Although AMBA has been so far described, it shall be evident, without any further description, to anyone of ordinary skill in the art that the present invention can be identically or equivalently applied any type of interface structure.

It shall be also evident that the present invention can be applied without any restriction to any type of electrical/electronic device having a processor chip, such as a personal computer, a notebook computer, and a portable device, including a PDA (personal digital assistant) and PMP (personal multimedia player).

As described above, the present invention can process data quickly by coupling a baseband processor to an external memory through a plurality of buses to allow a plurality of elements (e.g. a process module) to access an external memory simultaneously.

The present invention can also minimize a bottleneck problem when each processor in the microprocessor (e.g. the baseband processor) processes data by accessing the external memory.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

What is claimed is:

1. A microprocessor, comprising two or more external memory controllers coupled to a system bus,
wherein each of the external memory controllers is individually coupled to an external memory through its respective port.

2. The microprocessor of claim 1, further comprising:
n processors coupled to the system bus, n being a natural number; and
a master/slave, being coupled to the system bus and having a plurality of modules accessing the external memory through the external memory controller by a control of a processor or a predetermined processor.

3. The microprocessor of claim 1, wherein the microprocessor is an AMBA-based platform, and the system bus is an AHB bus.

4. The microprocessor of claim 1, wherein the external memory has two or more ports.

5. The microprocessor of claim 1, wherein the microprocessor is a baseband processor.

6. A microprocessor, comprising:
a processor, being coupled to a system bus;
an external memory controller, being coupled to the system bus and processing data communication with an external memory; and
a master/slave, being coupled to the system bus and having a plurality of modules accessing the external memory through the external memory controller by a control of the processor,
wherein the external memory has two or more ports and is individually coupled to the external memory through each port.

7. The microprocessor of claim 6, wherein the microprocessor is an AMBA-based platform, and the system bus is an AHB bus.

8. The microprocessor of claim 6, wherein the external memory has two or more ports.

9. The microprocessor of claim 6, wherein the microprocessor is a baseband processor.
